(19) United States
(12) Patent Application Publication
(10) Pub. No.: US 2006/0280934 A1
(43) Pub. Date: Dec. 14, 2006

(54) Flame-resistant coated polycarbonate mouldings

(76) Inventors: Eckhard Wenz, Koln (DE); Thomas Eckel, Dormagen (DE); Bernhard Schartel, Berlin (DE); Uwe Beck, Falkensee (DE); Andreas Hertwig, Berlin (DE); Matthias Weise, Berlin (DE); Johannes Strumpfel, Dresden (DE); Ekkehart Reinhold, Langebruck (DE)

Correspondence Address: BAYER MATERIAL SCIENCE LLC, 100 BAYER ROAD, PITTSBURGH, PA, 15205, US

(21) Appl. No.: 11/446,751

(22) Filed: Jun. 5, 2006

(30) Foreign Application Priority Data
Jun. 9, 2005 (DE) 102005026484.0
Apr. 21, 2006 (DE) 102006018602.8

(51) Int. Cl. B32B 15/08; B32B 15/082; B32B 15/085; B32B 15/088; B32B 15/09; B32B 15/095

(52) U.S. Cl. 428/336; 428/411.1; 428/457; 428/626; 428/625; 428/425.8; 428/461; 428/458; 428/463; 428/412

(57) ABSTRACT

The present invention relates to a multilayer product (composite material), wherein the first layer is a layer which is optically dense in the infrared range, and wherein the second layer contains a polymer (plastics) as substrate. The invention additionally relates to a method of improving the flame resistance of mouldings made from polymers and to a method of producing the multilayer products as well as to components which contain the above-mentioned multilayer products.

The present invention relates to a multilayer product (composite material), wherein the first layer is a layer which is optically dense in the infrared range, and wherein the second layer contains a polymer (plastics) as substrate. The invention additionally relates to a method of improving the flame resistance of mouldings made from polymers and to a method of producing the multilayer products as well as to components which contain the above-mentioned multilayer products.

There are a large number of technical solutions for flameproofing flammable materials, such as plastics (polymers) and related materials such as wood, paper, etc. Additives are used extensively, as are reactively modified matrix systems. In some applications, coatings are used to achieve flameproofing without modifying the material, such coatings comprising intumescent paints or intumescent gel coatings.

Coatings are used in particular in the case of materials where it is not possible to incorporate flame-proofing substances in the material, such as for example wood, thermosets or steel, but are not restricted to these classes of material. Successful systems are mostly based on the principle of intumescence, i.e. at elevated temperatures the coatings expand to form a thermally and mechanically stable, multicellular, thermally insulating char. Heat-insulating coatings also exist. All these systems are based on the principle of heat insulation.

Particular shortcomings of the previous solutions are: an unfavourable price/performance relationship, the use of environmentally problematic flame retardants and an inadequate range of properties with regard to using polymers in novel applications. Due to the introduction of new fire prevention requirements and regulations, there is a constant need to develop fire prevention systems further and to demonstrate new strategies for the achievement thereof. At present, the following requirements should be emphasised: a) achievement of halogen-free flameproofing, b) effective flameproofing using the smallest possible quantity of flame retardant and c) flameproofing on exposure to elevated levels of external radiant heat.

The object of the present invention is to provide polymers with improved flame resistance, wherein it is intended for the flameproofing to be halogen-free and to be as effective as possible, i.e. using the smallest possible quantity of flame retardant, and it is additionally intended to ensure flameproofing on exposure to elevated levels of external radiant heat. In the case of composite materials with a multilayer structure, the layers have to adhere well or exhibit low mechanical stresses and optionally layers located at the surface have to reproduce well the surface textures of the substrate.

It has surprisingly been found that the flame resistance of mouldings made from polymers, in particular those based on thermoplastics, may be decisively improved by the coating described below with a layer of metal which is optically dense in the infrared range.

Metallic coatings applied to polymeric materials by means of ECD (electro-coating deposition), PVD (physical vapour deposition) and CVD (chemical vapour deposition) methods have long been known in various fields of application.

This applies in particular to electrically conductive layers (e.g. copper) on polymers (sheets or films). In this field, metallic layers have been used on an industrial scale for several decades (printed circuit boards) or for around ten years (multilayer PCBs). A physically relevant property absent from the uncoated substrate is electrical conductivity.

Metal layers on polymers have also been mass-produced for several decades for optical applications, for example aluminium layers for headlamp reflectors. A physically relevant property absent from the uncoated substrate is (greater) reflectivity in the visible range of the spectrum.

The same applies to barrier layers of metal, which, sometimes in combination with other layers, seal packaging material (e.g. polymer films) in light- and water vapour-tight manner (e.g. foodstuffs packaging for freeze-dried coffee). Physically relevant properties absent from the uncoated substrate are lower transmittance in the visible range of the spectrum and a better water vapour blocking action.

Metallic layers applied to polymeric materials also find use in the field of electromagnetic shielding, e.g. for cell phone casings. A physically relevant property absent from the uncoated substrate is the electromagnetic wave blocking action.

No applications for metallic coatings are known in the field of fire- or flameproofing.

The invention therefore provides a multilayer product (composite material), wherein the first layer (S1) is a layer which is optically dense in the infrared range, and wherein the second layer (S2) contains a polymer (plastics) as substrate. The invention additionally relates to a method of improving the flame resistance of mouldings made from polymers, a method of producing the multilayer products and components which contain the above-mentioned multilayer products.

The metallic coating for improving flameproofing is based on the principle of increasing reflectance in the radiation range relevant for flameproofing (NR to IR, 0.5 to 10 μm wavelength). In this way, it is typically possible to achieve a reduction in energy absorbed relative to the thermal radiation of a heat source to less than 60%, preferably to less than 5%, relative to uncoated polymeric materials not modified for flameproofing purposes.

Structure of the First Layer (S1)

In the context of this invention, a layer which is optically dense in the infrared range should be understood to be a layer which, assuming a 1300 K black body radiator, exhibits integral reflectivity over the 0.5 μm-10 μm range of the spectrum of greater than 35%, preferably greater than 40%, particularly preferably greater than 95%.

The layer S1 is preferably made up of metal or another sufficiently integrally IR-reflective material. All metals are in principle suitable as the metal for such a layer S1, the metal of layer S1 being selected in particular from the main group 1 to 5 or subgroup 1 to 8 of the periodic system, preferably main group 2 to 5 or subgroup 1 to 8, particularly preferably main group 3 to 5 or the subgroup 1, 6 or 8, preference being given to copper, aluminium, gold, silver, chromium and nickel and particular preference to copper, aluminium and chromium. Alloys of at least two of the above-stated metals or also stainless steel may also be used. Other sufficiently IR-reflective materials to make up the layer S1 are the group of hard material layers, such as for example and preferably TiN (titanium nitride).

The layer S1 has to be optically dense in the infrared range, which typically requires a film thickness of from 3 nm to 10000 μm, preferably from 5 nm-1000 nm, particularly preferably from 5 nm to 600 nm, in order to achieve a flameproofing action based on integral IR reflection of equal quality throughout.

Suitable methods for coating the polymer with a layer S1 are all classes of method involving thin-film technology, i.e. PVD (physical vapour deposition), ECD (electro-coating deposition), CVD (chemical vapour deposition) and sol-gel methods, in particular vapour deposition, sputtering (cathode sputtering), dip, centrifugal and spray coating, both for direct coating and for coating films or sheets to be attached by lamination or adhesion. Preferred suitable methods are PVD (physical vapour deposition) processes, or ECD (electro-coating deposition) methods. The PVD (physical vapour deposition) method is particularly preferred, in particular electron beam vapour deposition and PVD sputtering, electron beam vapour deposition being the most preferred.

In order to fulfil stringent requirements in use (in particular with regard to adhesive strength, flameproofing functionality, resistance to environmental influences, scratch resistance), coating is preferably performed in a multistage treatment or coating process. The coating according to the invention therefore comprises in a preferred embodiment a coupling layer (H), a functional layer (F) and optionally a protective layer (S), such that the following layer structure results:

$$\begin{matrix}Protective layer ( S ) ( optional ) \\ Functional layer ( F ) \\ Coupling layer ( H )\end{matrix} \} Layer S 1 \\ Substrate ( polymer ) \} Layer S 2$$

The coupling layer (H) consists of a metal such as chromium, nickel, a nickel/chromium alloy or of stainless steel, the coupling layer preferably consisting of chromium. The coupling layer (H) exhibits film thicknesses of from 1 nm to 200 nm, preferably 3 nm to 150 μm, particularly preferably 5 nm to 100 nm. In the case of a relatively large film thickness, the coupling layer may itself also be functional. Preferably in combination with activation of the substrate surface (in particular in uninterrupted process sequence), satisfactory anchoring of the subsequent functional layer (F) to the substrate is achieved by the coupling layer (H).

The functional layer (F) consists of the best heat-reflecting material possible, such as for example and preferably a metal or another sufficiently integrally IR-reflective material. In particular, the material of the functional layer is selected from a metal from the main group 1 to 5 or subgroup 1 to 8 of the periodic system, preferably main group 2 to 5 or subgroup 1 to 8, particularly preferably main group 3 to 5 or subgroup 1, 6 or 8, aluminum, copper, gold, silver, chromium and nickel being particularly preferred, with copper being most preferred. Alloys of at least two of the above-stated metals, in particular nickel/chromium alloy, as well as stainless steel and hard layers, such as for example titanium nitride (TiN) are also suitable. The functional layer must be optically dense in the infrared range, which typically requires a film thickness of from 3 nm to 10000 nm, preferably from 5 nm-1000 nm, particularly preferably from 5 nm to 600 nm, in order to achieve a flameproofing action which is of equal quality throughout. The exact film thickness requirements for achieving an integral reflectivity over the 0.5 μm-10 μm range of the spectrum of greater than 35%, preferably greater than 40%, particularly preferably greater than 95% (assuming a 1300 K black-body radiator as heat source) vary in accordance with the specific reflection characteristics of the metal used for the functional layer. In the case of copper, for example, a film thickness of 5 nm results in an integral reflectivity of 38% (using a 5 nm thick chromium layer as coupling layer (H)). In the case of copper, a film thickness of 500 nm results in a reflectivity of 96.8% (using a 100 nm thick chromium layer as coupling layer (H)), see practical example. When using gold as the metal for the functional layer (F), a film thickness of 5 nm results in a corresponding integral reflectivity of 49% (using a 5 nm thick chromium layer as coupling layer (H)) and a gold film thickness of 500 nm results in a reflectivity of 97.6% (using a 100 nm thick chromium layer as coupling layer (H)).

The coating according to the invention optionally and preferably comprises a protective layer (S), preferably based on an oxide material or metal oxide or a hard layer. The protective layer (S) preferably consists of at least one component selected from the group consisting of SiO₂, TiO₂, Al₂O₃ and hard layers such as for example titanium nitride (TiN). The protective layer particularly preferably consists of SiO₂. The protective layer typically has a film thickness of from 10 nm to 1000 nm, preferably 15 nm-500 μm, particularly preferably 50 nm to 150 nm. The protective layer provides the advantage that negative long-term influences (for example corrosion of the metal) are prevented or a high scratch resistance is achieved for the coating and thus for the surface of the composite material. The protective layer is particularly advantageous when the functional layer is made up of a metal which is not self-passivating with regard to degradation (for example in the case of copper inter alia the formation of verdigris) nor scratch-resistant, which is the case for example with copper.

In addition to the actual flameproofing function, further properties such as coupling, provision of a hermetic seal, provision of a barrier effect, scratch resistance and a decorative effect may be achieved by individual layers or the multilayer composite.

Suitable coating methods for coating the substrate (polymer) with a coupling layer (H), a functional layer (F) and optionally a protective layer (S) are all classes of method involving thin-film technology, i.e. PVD and CVD methods and sol-gel methods, in detail in particular vapour deposition, sputtering (cathode sputtering), dip, centrifugal and spray coating, both for direct coating and for coating films or sheets to be attached by lamination or adhesion. Also worthy of mention as suitable is the class of method involving the ECD method, in particular for thicker layers and pure metallisation. The PVD (physical vapour deposition) method is preferred, in particular electron beam vapour deposition and PVD sputtering, electron beam vapour deposition being particularly preferred.

The coating itself must in any case be conformed to the base material and its form (moulding or film). In this respect, the practical example described further below deals with just one of the possible forms, to cover the range of requirements.

A step which is preferably provided, prior to coating proper, effects cleaning or activation of the substrate surface. This cleaning or activation of the substrate surface preferably proceeds by ion-assisted activation in an Ar/O₂ mixture or by plasma-activated processes or by means of wet-chemical activation steps. This cleaning or activation of the substrate surface particularly preferably proceeds by ion-assisted activation in an Ar/O₂ mixture.

Structure of the Second Layer (S2), “Substrate”

As substrate, all polymers are in principle suitable for the method according to the invention, that is to say thermoplastics, thermosets and even rubbers. Polymers which may be used according to the invention are listed for example in Saechtling, Kunststoff-Taschenbuch, 26th edition, Carl Hanser Verlag, Munich, Vienna, 1995.

Possible examples of thermoplastics are polystyrene, polyurethane, polyamide, polyester, polyacetal, polyacrylate, polycarbonate, polyethylene, polypropylene, polyvinyl chloride, polystyrene/acrylonitrile and copolymers based on the stated polymers and mixtures of the stated polymers and copolymers or with further polymers.

Suitable rubber-type polymers are for example polyisoprene, polychloroprene, styrene-butadiene rubber, rubbery ABS polymers and copolymers of ethylene and at least one compound selected from the group consisting of vinyl acetate, acrylic acid ester, methacrylic acid ester and propylene.

In addition, the polymers used may also take the form of resins such as unsaturated polyesters, epoxy resin compositions, acrylates, formaldehyde resins.

Preferably used to make up the second layer (substrate) are thermoplastics, in particular those based on polycarbonate, i.e. which contain polycarbonate or consist thereof.

Thermoplastics which are particularly preferred are compositions which contain aromatic polycarbonate and/or aromatic polyester carbonate as component A and at least one further polymer selected from the group consisting of vinyl (co)polymers, rubber-modified vinyl (co)polymers and polyesters as component B.

In a preferred embodiment, layer S2 is thus a polycarbonate composition containing
A) 40-100 parts by weight, preferably 60-95 parts by weight, particularly preferably 65-85 parts by weight of aromatic polycarbonate and/or aromatic polyester carbonate,
B) 0-40 parts by weight, preferably 2-30 parts by weight, particularly preferably 4-25 parts by weight of a polymer selected from the group consisting of vinyl (co)polymers, rubber-modified vinyl (co)polymers and polyesters,
C) 0 to 5 parts by weight, 0 to 1 part by weight, particularly preferably from 0.1 to 0.5 parts by weight, especially preferably from 0.2 to 0.5 parts by weight of fluorinated polyolefin, wherein these stated quantities relate to the pure fluorinated polyolefin when using a coagulate, precompound or masterbatch,
D) 0-20 parts by weight, preferably 5-17 parts by weight, particularly preferably 8-15 parts by weight of flame-retardant additives, and
E) 0-25 parts by weight, preferably 0.01-20, particularly preferably 0.1-5 parts by weight of further polymers and/or polymer additives,
   wherein all parts by weight stated in the present application are so standardised that the sum of the parts by weight of all the components in the composition amounts to 100.
   Component A

Suitable according to the invention as thermoplastics are, for example and preferably, aromatic polycarbonates and/or aromatic polyester carbonates. These are known from the literature or may be produced using methods known from the literature, such as for example the phase boundary method or the melt polymerisation method (for the production of aromatic polycarbonates see for example Schnell, “Chemistry and Physics of Polycarbonates”, Interscience Publishers, 1964 and DE-AS 1 495 626, DE-A 2 232 877, DE-A 2 703 376, DE-A 2 714 544, DE-A 3 000 610, DE-A 3 832 396; for the production of aromatic polyester carbonates see for example DE-A 3 077 934).

The production of aromatic polycarbonates proceeds for example by reacting diphenols with carbonic acid halides, preferably phosgene, and/or with aromatic dicarboxylic acid dihalides, preferably benzenedicarboxylic acid dihalides, by the phase boundary method, optionally using chain terminators, for example monophenols, and optionally using trifunctional or greater than trifunctional branching agents, for example triphenols or tetraphenols.

Diphenols for producing aromatic polycarbonates and/or aromatic polyester carbonates are preferably those of the formula (I) 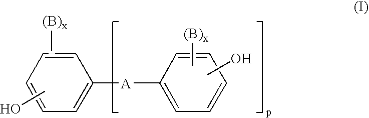
wherein
A is a single bond, C₁ to C₅ alkylene, C₂ to C₅ alkylidene, C₅ to C₆ cycloalkylidene, —O—, —SO—, —CO—, —S—, —SO₂—, C₆ to C₁₂ arylene, to which further aromatic rings optionally containing heteroatoms may be fused or a residue of the formula (II) or (III), 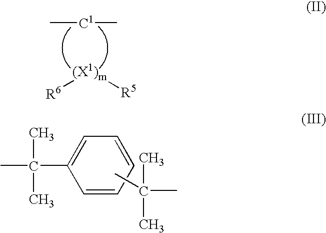
B is in each case C₁ to C₁₂ alkyl, preferably methyl, halogen, preferably chlorine and/or bromine
x is in each case mutually independently 0, 1 or 2,
p is 1 or 0, and
R⁵ and R⁶, individually selectably for each X¹, mutually independently mean hydrogen or C₁ to C₆ alkyl, preferably hydrogen, methyl or ethyl,
X¹ means carbon and
m denotes an integer from 4 to 7, preferably 4 or 5, with the proviso that on at least one atom X¹, R⁵ and R⁶ are simultaneously alkyl.

Preferred diphenols are hydroquinone, resorcinol, dihydroxydiphenols, bis(hydroxyphenyl)-C₁-C₅-alkanes, bis(hydroxyphenyl)-C₅-C₆-cycloalkanes, bis-(hydroxyphenyl) ethers, bis(hydroxyphenyl) sulfoxides, bis(hydroxyphenyl) ketones, bis(hydroxyphenyl) sulfones and α,α-bis(hydroxyphenyl)diisopropyl-benzenes as well as the nuclear-brominated and/or nuclear-chlorinated derivatives thereof.

Particularly preferred diphenols are 4,4′-dihydroxydiphenyl, bisphenol A, 2,4-bis(4-hydroxy-phenyl)-2-methylbutane, 1,1-bis(4-hydroxyphenyl)cyclohexane, 1,1-bis(4-hydroxyphenyl)-3,3,5-trimethylcyclohexane, 4,4′-dihydroxydiphenyl sulfide, 4,4′-dihydroxydiphenyl sulfone and the di- and tetrabrominated or chlorinated derivatives thereof such as for example 2,2-bis(3-chloro-4-hydroxyphenyl)propane, 2,2-bis(3,5-dichloro-4-hydroxyphenyl)propane or 2,2-bis(3,5-dibromo-4-hydroxy-phenyl)propane. 2,2-Bis(4-hydroxyphenyl)propane (bisphenol A) is particularly preferred.

The diphenols may be used individually or as any desired mixtures. The diphenols are known from the literature or may be obtained using processes known from the literature.

Chain terminators suitable for the production of thermoplastic, aromatic polycarbonates (component A) are for example phenol, p-chlorophenol, p-tert.-butylphenol or 2,4,6-tribromophenol, and also long-chain alkylphenols, such as 4-(1,3-tetramethylbutyl)phenol according to DE-A 2 842 005 or monoalkylphenol or dialkylphenols with a total of 8 to 20 C atoms in the alkyl substituents, such as 3,5-di-tert.-butylphenol, p-iso-octylphenol, p-tert.-octylphenol, p-dodecylphenol and 2-(3,5-dimethylheptyl)phenol and 4-(3,5-dimethylheptyl)phenol. The quantity of chain terminators to be used amounts in general to between 0.5 mol %, and 10 mol %, relative to the total number of moles of the diphenols used in each case.

The thermoplastic, aromatic polycarbonates may be branched in known manner, preferably by incorporating 0.05 to 2.0 mol %, relative to the total of the diphenols used, of trifunctional or greater than trifunctional compounds, for example those with three or more phenolic groups.

Both homopolycarbonates and copolycarbonates are suitable. To produce copolycarbonates according to component A according to the invention, it is also possible to use 1 to 25 wt. %, preferably 2.5 to 25 wt. % (relative to the total quantity of diphenols to be used) of polydiorganosiloxanes with hydroxyaryloxy terminal groups. These are known (for example U.S. Pat. No. 3,419,634) or may be produced using processes known from the literature. The production of copolycarbonates containing polydiorganosiloxanes is described in DE-A 3 334 782 for example.

In addition to bisphenol A homopolycarbonates, preferred polycarbonates are the copolycarbonates of bisphenol A with up to 15 mol %, relative to the total number of moles of diphenols, of diphenols other than those stated to be preferred or particularly preferred.

Aromatic dicarboxylic acid dihalides for the production of aromatic polyester carbonates are preferably the diacid dichlorides of isophthalic acid, terephthalic acid, 4,4-diphenyletherdicarboxylic acid and 2,6-naphthalenedicarboxylic acid.

Mixtures of aromatic dicarboxylic dihalides may also be used, mixtures of the diacid dichlorides of isophthalic acid and terephthalic acid in the ratio of between 1:20 and 20:1 being particularly preferred.

When producing polyester carbonates, a carbonic acid halide, preferably phosgene, is additionally used as a difunctional acid derivative.

In addition to the monophenols already mentioned, suitable chain terminators for the production of aromatic polyester carbonates are the chloroformic acid esters of said monophenols as well as the acid chlorides of aromatic monocarboxylic acids, which may optionally be substituted by C₁ to C₂₂ alkyl groups or by halogen atoms, and aliphatic C₂ to C₂₂ monocarboxylic acid chlorides.

The quantity of chain terminators amounts in each case to 0.1 to 10 mol %, relative, in the case of phenolic chain terminators, to the moles of diphenols and, in the case of monocarboxylic acid chloride chain terminators, to the moles of dicarboxylic acid dichlorides.

Aromatic hydroxycarboxylic acids may also be incorporated into the aromatic polyester carbonates.

The aromatic polyester carbonates may be both linear and branched in known manner (see in this respect also DE-A 2 940 024 and DE-A 3 007 934).

The branching agents used may be for example tri- or polyfunctional carboxylic acid chlorides, such as trimesic acid trichloride, cyanuric acid trichloride, 3,3′,4,4′-benzophenone tetracarboxylic acid tetrachloride, 1,4,5,8-naphthalenetetracarboxylic acid tetrachloride or pyromellitic acid tetrachloride in quantities of 0.01 to 1.0 mol % (relative to the dicarboxylic acid dichlorides used) or tri- or polyfunctional phenols, such as phloroglucinol, 4,6-dimethyl-2,4,6-tri-(4-hydroxyphenyl)hept-2-ene, 4,4-di-methyl-2,4-6-tri-(4-hydroxyphenyl)heptane, 1,3,5-tri-(4-hydroxyphenyl)benzene, 1,1,1-tri-(4-hydroxyphenyl)ethane, tri-(4-hydroxyphenyl)phenylmethane, 2,2-bis-[4,4-bis(4-hydroxyphenyl)cyclohexyl]propane, 2,4-bis(4-hydroxyphenylisopropyl)-phenol, tetra-(4-hydroxyphenyl)methane 2,6-bis(2-hydroxy-5-methyl-benzyl)-4-methylphenol, 2-(4-hydroxyphenyl)-2-(2,4-dihydroxyphenyl)propane, tetra-(4-[4-hydroxyphenylisopropyl]phenoxy)methane, 1,4-bis[4,4′-dihydroxytriphenyl)-methyl]benzene, in quantities of 0.01 to 1.0 mol % relative to the diphenols used. Phenolic branching agents may be initially introduced with the diphenols, while acid chloride branching agents may be introduced together with the acid dichlorides.

The proportion of carbonate structural units in the thermoplastic, aromatic polyester carbonates may vary as desired. The proportion of carbonate groups preferably amounts to up to 100 mol %, in particular up to 80 mol %, particularly preferably up to 50 mol %, relative to the total number of ester groups and carbonate groups. Both the ester and the carbonate moieties of the aromatic polyester carbonates may be present in the polycondensation product in the form of blocks or randomly distributed.

The thermoplastic, aromatic poly(ester)carbonates have average weight-average molecular weights (M_{w}, measured for example by ultracentrifuge, light scattering measurement or gel permeation chromatography) of 10,000 to 200,000, preferably 15,000 to 80,000, particularly preferably 17,000 to 40,000.

The thermoplastic, aromatic polycarbonates and polyester carbonates may be used alone or in any desired mixture.

Component B

Preferred rubber-modified vinyl (co)polymers are graft polymers comprising at least one vinyl monomer grafted onto at least one rubber with a glass transition temperature of <10° C. as grafting backbone, in particular such graft polymers comprising
B.1 5 to 95 wt. %, preferably 10 to 90 wt. %, in particular 20 to 70 wt. % of monomers of a mixture of
B.1.1 50 to 99 wt. %, preferably 50 to 90 wt. %, particularly preferably 55 to 85 wt. %, very particularly preferably 60 to 80 wt. % of vinyl aromatics and/or nuclear-substituted vinyl aromatics (such as for example styrene, α-methylstyrene, p-methylstyrene, p-chlorostyrene) and/or methacrylic acid (C₁-C₈)-alkyl esters (such as methyl methacrylate, ethyl methacrylate) and
B.1.2 1 to 50 wt. %, preferably 10 to 50 wt. %, particularly preferably 15 to 45 wt. %, very particularly preferably 20 to 40 wt. % of vinyl cyanides (unsaturated nitrites such as acrylonitrile and methacrylonitrile) and/or (meth)acrylic acid (C₁-C₈)-alkyl esters (such as methyl methacrylate, n-butyl acrylate, t-butyl acrylate) and/or derivatives (such as anhydrides and imides) of unsaturated carboxylic acids (for example maleic anhydride and N-phenylmaleimide) grafted onto
B.2 95 to 5 wt. %, preferably 90 to 10 wt. %, in particular 80 to 30 wt. % of one or more rubbers with glass transition temperatures of <10° C., preferably of <0° C., particularly preferably of <−20° C. as grafting backbone.

The grafting backbone has in general an average particle size (d₅₀ value) of 0.05 to 10 μm, preferably 0.1 to 5 μm, particularly preferably 0.2 to 1 μm.

The average particle size d₅₀ is the diameter above and below which are located in each case 50 wt. % of the particles. It may be determined by means of ultracentrifuge measurement (W. Scholtan, H. Lange, Kolloid, Z. und Z. Polymere 250 (1972), 782-1796).

Preferred monomers B.1.1 are selected from among at least one of the monomers styrene, α-methylstyrene and methyl methacrylate, preferred monomers B.1.2 being selected from among at least one of the monomers acrylonitrile, maleic anhydride and methyl methacrylate.

Monomers which are particularly preferred are styrene and acrylonitrile.

Grafting backbones B.2 suitable for the graft polymers are for example diene rubbers, EP(D)M rubbers, i.e. those based on ethylene/propylene and optionally diene, acrylate, polyurethane, silicone, chloroprene and ethylene/vinyl acetate rubbers and composite rubbers consisting of two or more of the above-stated systems.

Preferred grafting backbones are diene rubbers. Diene rubbers for the purposes of the present invention are those based for example on butadiene, isoprene etc. or mixtures of diene rubbers or copolymers of diene rubbers or mixtures thereof with further copolymerisable monomers, such as for example butadiene/styrene copolymers, with the proviso that the glass transition temperature of the grafting backbone is <10° C., preferably <0° C., particularly preferably <−10° C.

Pure polybutadiene rubber is particularly preferred.

Particularly preferred graft polymers are for example ABS polymers (emulsion, bulk and suspension ABS), as described for example in DE-A 2 035 390 (=U.S. Pat. No. 3,644,574) or in DE-A 2 248 242 (=GB patent 1 409 275) or in Ullmanns Enzyklopädie der Technischen Chemie, vol. 1.9 (1980), p. 280 et seq. The gel fraction of the grafting backbone preferably amounts to at least 30 wt. %, in particular at least 40 wt. %.

The gel content of the grafting backbone is determined at 25° C. in toluene (M. Hoffmann, H. Krömer, R. Kuhn, Polymeranalytik I and II, Georg Thieme-Verlag, Stuttgart 1977).

The graft copolymers may be produced by free-radical polymerisation, for example by emulsion, suspension, solution or bulk polymerisation. They are preferably produced by emulsion or bulk polymerisation.

Further particularly suitable graft rubbers are ABS polymers produced by redox initiation with an initiator system comprising organic hydroperoxide and ascorbic acid according to U.S. Pat. No. 4,937,285.

Acrylate rubbers suitable as the grafting backbone are preferably polymers of acrylic acid alkyl esters, optionally also copolymers with up to 40 wt. %, relative to the grafting backbone, of other polymerisable, ethylenically unsaturated monomers. The preferred polymerisable acrylic acid esters include C₁-C₈ alkyl esters, for example methyl, ethyl, butyl, n-octyl and 2-ethylhexyl esters; haloalkyl esters, preferably halo-C₁-C₈-alkyl esters, such as chloroethyl acrylate and mixtures of these monomers.

For crosslinking, monomers with more than one polymerisable double bond may be copolymerised. Preferred examples of crosslinking monomers are esters of unsaturated monocarboxylic acids with 3 to 8 C atoms and unsaturated monovalent alcohols with 3 to 12 C atoms, or saturated polyols with 2 to 4 OH groups and 2 to 20 C atoms, such as ethylene glycol dimethacrylate, allyl methacrylate; polyunsaturated heterocyclic compounds, such as trivinyl and triallyl cyanurate; polyfunctional vinyl compounds, such as di- and trivinylbenzenes; and also triallyl phosphate and diallyl phthalate.

Preferred crosslinking monomers are allyl methacrylate, ethylene glycol dimethacrylate, diallyl phthalate and heterocyclic compounds comprising at least three ethylenically unsaturated groups.

Particularly preferred crosslinking monomers are the cyclic monomers triallyl cyanurate, triallyl isocyanurate, triacryloylhexahydro-s-triazine, triallyl benzenes. The quantity of crosslinked monomers amounts preferably to 0.02 to 5, in particular 0.05 to 2 wt. %, relative to the grafting backbone.

In the case of cyclic crosslinking monomers with at least three ethylenically unsaturated groups, it is advantageous to restrict the quantity to below 1 wt. % of the grafting backbone.

Preferred “other” polymerisable, ethylenically unsaturated monomers, which may, in addition to the acrylic acid esters, optionally serve to produce the grafting backbone, are for example acrylonitrile, styrene, α-methylstyrene, acrylamides, vinyl C₁-C₆-alkyl ethers, methyl methacrylate, butadiene. Acrylate rubbers preferred as the grafting backbone are emulsion polymers, which exhibit a gel content of at least 60 wt. %.

Further suitable grafting backbones are silicone rubbers with active grafting sites, such as are described in DE-A 3 704 657, DE-A 3 704 655, DE-A 3 631 540 and DE-A 3 631 539.

Preferred suitable vinyl (co)polymers are polymers of at least one monomer from the group of vinyl aromatics, vinyl cyanides (unsaturated nitrites), (meth)acrylic acid (C₁ to C₈) alkyl esters, unsaturated carboxylic acids and derivatives (such as anhydrides and imides) of unsaturated carboxylic acids. Particularly suitable are (co)polymers comprising

50 to 99, preferably 60 to 80 wt. % of vinyl aromatics and/or nuclear-substituted vinyl aromatics (such as for example styrene, α-methylstyrene, p-methylstyrene, p-chlorostyrene) and/or methacrylic acid (C₁ to C₈)-alkyl esters (such as methyl methacrylate, ethyl methacrylate), and

1 to 50, preferably 20 to 40 wt. % of vinyl cyanides (unsaturated nitrites) such as acrylonitrile and methacrylonitrile and/or (meth)acrylic acid (C₁-C₈)-alkyl esters (such as methyl methacrylate, n-butyl acrylate, t-butyl acrylate) and/or unsaturated carboxylic acids (such as maleic acid) and/or derivatives (such as anhydrides and imides) of unsaturated carboxylic acids (for example maleic anhydride and N-phenylmaleimide).

The (co)polymers are resinous and thermoplastic.

Polymethyl methacrylate and the copolymer of styrene and acrylonitrile are particularly preferred.

The (co)polymers are known and may be produced by free-radical polymerisation, in particular by emulsion, suspension, solution or bulk polymerisation. The (co)polymers preferably have average molecular weights M_{w} (weight average, determined by light scattering or sedimentation) of between 15,000 and 200,000.

Suitable polyesters which are preferred are aromatic polyesters, in particular polyalkylene terephthalates. These comprise reaction products from aromatic dicarboxylic acids or the reactive derivatives thereof, such as dimethyl esters or anhydrides, and aliphatic, cycloaliphatic or araliphatic diols and mixtures of these reaction products.

Preferred polyalkylene terephthalates contain at least 80 wt. %, preferably at least 90 wt. %, relative to the dicarboxylic acid component of terephthalic acid residues and at least 80 wt. %, preferably at least 90 mol %, relative to the diol component of ethylene glycol and/or 1,4-butanediol residues.

In addition to terephthalic acid residues, the preferred polyalkylene terephthalates may contain up to 20 mol %, preferably up to 10 mol %, of residues of other aromatic or cycloaliphatic dicarboxylic acids with 8 to 14 C atoms or aliphatic dicarboxylic acids with 4 to 12 C atoms, such as residues of phthalic acid, isophthalic acid, 2,6-naphthalenedicarboxylic acid, 4,4′-diphenyldicarboxylic acid, succinic acid, adipic acid, sebacic acid, azelaic acid, cyclohexanediacetic acid.

In addition to ethylene glycol or 1,4-butanediol residues, the preferred polyalkylene terephthalates may contain up to 20 mol %, preferably up to 10 mol %, of other aliphatic diols with 3 to 12 C atoms or cycloaliphatic diols with 6 to 21 C atoms, e.g. residues of 1,3-propanediol, 2-ethyl-1,3-propanediol, neopentyl glycol, 1,5-pentanediol, 1,6-hexanediol, 1,4-cyclohexanedimethanol, 3-ethyl-2,4-pentanediol, 2-methyl-2,4-pentanediol, 2,2,4-trimethyl-1,3-pentanediol, 2-ethyl-1,3-hexanediol, 2,2-diethyl-1,3-propanediol, 2,5-hexanediol, 1,4-di-(β-hydroxyethoxy)benzene, 2,2-bis(4-hydroxycyclohexyl)propane, 2,4-dihydroxy-1,1,3,3-tetramethylcyclobutane, 2,2-bis(4-β-hydroxyethoxyphenyl)propane and 2,2-bis(4-hydroxypropoxy-phenyl)propane (DE-A 2 407 674, 2 407 776, 2 715 932).

The polyalkylene terephthalates may be branched by the incorporation of relatively small quantities of tri- or tetrahydric alcohols or tri- or tetrabasic carboxylic acids, for example according to DE-A 1 900 270 and U.S. Pat. No. 3,692,744. Examples of preferred branching agents are trimesic acid, trimellitic acid, trimethylolethane, trimethylolpropane and pentaerythritol.

Polyalkylene terephthalates which are particularly preferred are those which have been produced solely from terephthalic acid and the reactive derivatives thereof (e.g. the dialkyl esters thereof) and ethylene glycol and/or 1,4-butanediol, and mixtures of these polyalkylene terephthalates.

Preferred mixtures of polyalkylene terephthalates contain 0 to 50 wt. %, preferably 0 to 30 wt. %, of polybutylene terephthalate and 50 to 100 wt. %, preferably 70 to 100 wt. %, of polyethylene terephthalate. Polyethylene terephthalate is particularly preferred.

The polyalkylene terephthalates preferably used generally have an intrinsic viscosity of 0.4 to 1.5 dl/g, preferably 0.5 to 1.2 dl/g, measured in phenol/o-dichlorobenzene (1:1 parts by weight) at 25° C. in an Ubbelohde viscosimeter.

The polyalkylene terephthalates may be produced in accordance with known methods (e.g. Kunststoff-Handbuch, Vol. VIII, p. 695 et seq., Carl Hanser Verlag, Munich, 1973).

Component C

Fluorinated polyolefins (component C) are optionally used in the polycarbonate compositions as so-called antidripping agents, which reduce the tendency of the material to drip burning droplets in the event of fire.

Fluorinated polyolefins are known and described for example in EP-A 0 640 655. They are sold for example by DuPont under the tradename Teflon® 30N.

The fluorinated polyolefins may be used both in pure form and in the form of a coagulated mixture of emulsions of the fluorinated polyolefins with emulsions of the graft polymers or with an emulsion of a copolymer (according to component B), preferably based on styrene/acrylonitrile or polymethyl methacrylate, wherein the fluorinated polyolefin is mixed as an emulsion with an emulsion of the graft polymer or of the copolymer and then coagulated.

Furthermore, the fluorinated polyolefins may be used as a precompound with the graft polymer or a copolymer, preferably based on styrene/acrylonitrile or polymethyl methacrylate. The fluorinated polyolefins are mixed as a powder with a powder or granules of the graft polymer or copolymer and compounded in the melt in general at temperatures of 200 to 330° C. in conventional units such as internal mixers, extruders or twin screw extruders.

The fluorinated polyolefins may also be used in the form of a masterbatch, which is produced by emulsion polymerisation of at least one monoethylenically unsaturated monomer In the presence of an aqueous dispersion of the fluorinated polyolefin. Preferred monomer components are styrene, acrylonitrile, methyl methacrylate and mixtures thereof. The polymer is used as a flowable powder after acidic precipitation and subsequent drying.

The coagulates, precompounds or masterbatches conventionally have contents of fluorinated polyolefin of from 5 to 95 wt. %, preferably 7 to 80 wt. %, in particular 8 to 60 wt. %. The above-stated usage concentrations of component C relate to the fluorinated polyolefin.

Component D

The polycarbonate compositions may contain flame-retardant additives as component D.

Possible flame-retardant additives are in particular preferably known phosphorus-containing compounds such as monomeric and oligomeric phosphoric and phosphonic acid esters, phosphonate amines, phosphoramidates and phosphazenes, silicones and optionally fluorinated alkyl- or arylsulfonic acid salts.

Phosphorus-containing flame retardants D for the purposes of the invention are preferably selected from among the groups of mono- and oligomeric phosphoric and phosphonic acid esters, phosphonate amines and phosphazenes, wherein mixtures of several components selected from among one or more of these groups may also be used as flame retardants. Other halogen-free phosphorus compounds not specifically mentioned here may be used alone or in any desired combination with other halogen-free phosphorus compounds.

Preferred mono- and oligomeric phosphoric or phosphoric acid esters are phosphorus compounds of the general formula (IV) 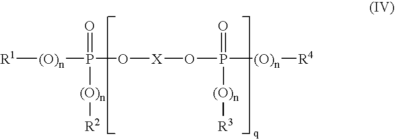
in which
R¹, R², R³ and R⁴, mutually independently denote in each case optionally halogenated C₁ to C₈ alkyl, C₅ to C₆ cycloalkyl, C₆ to C₂₀ aryl or C₇ to C₁₂ aralkyl in each case optionally substituted by alkyl, preferably C₁-C₄ alkyl, and/or halogen, preferably chlorine, bromine,
n mutually independently means 0 or 1
q means 0 to 30 and
X means a mono- or polynuclear aromatic residue with 6 to 30 C atoms, or a linear or branched aliphatic residue with 2 to 30 C atoms, which may be OH-substituted and contain up to 8 ether bonds.

Preferably, R¹, R², R³ and R⁴ mutually independently denote C₁-C₄ alkyl, phenyl, naphthyl or phenyl-C₁-C₄-alkyl. The aromatic groups R¹, R², R³ and R⁴ may for their part be substituted with halogen and/or alkyl groups, preferably chlorine, bromine and/or C₁-C₄ alkyl. Particularly preferred aryl residues are cresyl, phenyl, xylenyl, propylphenyl or butylphenyl and the corresponding brominated and chlorinated derivatives thereof.
X in the formula (IV) preferably means a mono- or polynuclear aromatic residue with 6 to 30 C atoms. This is preferably derived from diphenols of the formula (I).
n in the formula (IV) may mutually independently be 0 or 1, preferably n is equal to 1.
q denotes values from 0 to 30, preferably 0.3 to 20, particularly preferably 0.5 to 10, in particular 0.5 to 6, very particularly preferably 1.1 to 1.6.
x particularly preferably denotes 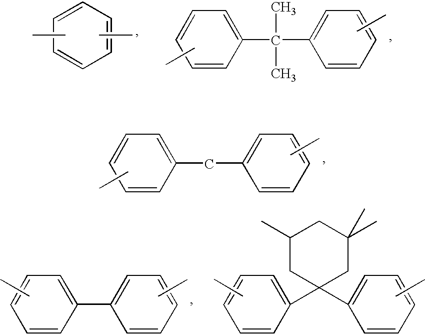
or the chlorinated or brominated derivatives thereof, in particular X is derived from resorcinol, hydroquinone, bisphenol A or diphenylphenol. Particularly preferably, X is derived from bisphenol A.

Mixtures of various phosphates may also be used as component D according to the invention.

Phosphorus compounds of the formula (IV) are in particular tributyl phosphate, triphenyl phosphate, tricresyl phosphate, diphenylcresyl phosphate, diphenyloctyl phosphate, diphenyl-2-ethylcresyl phosphate, tri(isopropylphenyl) phosphate, resorcinol-bridged diphosphate and bisphenol A-bridged diphosphate. The use of oligomeric phosphoric acid esters of the formula (IV), which are derived from bisphenol A, is particularly preferred.

The phosphorus compounds according to component D are known (cf. for example EP-A 0 363 608, EP-A 0 640 655) or may be produced in a manner which is similar to known methods (for example Ullmanns Enzyklopädie der technischen Chemie, vol. 18, p. 301 et seq. 1979; Houben-Weyl, Methoden der organischen Chemie, vol. 12/1, p. 43; Beilstein vol. 6, p. 177).

The average q values may be determined by determining the composition of the phosphate mixture (molecular weight distribution) using suitable methods (gas chromatography (GC), high pressure liquid chromatography (HPLC), gel permeation chromatography (GPC)) and calculating the average values for q therefrom.

Phosphonate amines and phosphazenes, as described in WO 00/00541 and WO 01/18105, may additionally be used as flame retardants.

The flame retardants may be used alone or in any desired mixture with one another or in a mixture with other flame retardants.

Component E

The polycarbonate compositions may contain further polymers and/or polymer additives as component E.

Examples of further polymers are in particular those which may demonstrate synergistic action in case of fire by assisting in the formation of a stable carbon layer. Polyphenylene oxides and sulfides, epoxy and phenolic resins, novolaks and polyethers are preferred.

Polymer additives which may possibly be used are stabilisers (such as for example heat stabilisers, hydrolysis stabilisers, light stabilisers), flow and processing auxiliaries, slip and mould release agents (for example pentaerythritol tetrastearate), UV absorbers, antioxidants, antistatic agents, preservatives, coupling agents, fibrous or particulate fillers and reinforcing materials (e.g. a silicate such as talcum or wollastonite), dyes, pigments, nucleating agents, impact modifiers, foaming agents, processing auxiliaries, finely divided (i.e. with an average particle size of from 1 to 200 nm) inorganic additives, further flame-retardant additives and agents for reducing smoke development and mixtures of the stated additives.

The mouldings according to the invention of layer S2 (substrate) are produced by mixing the respective components A to E in a known manner and melt-compounding and melt-extruding them at temperatures of 200° C. to 300° C. in conventional units such as internal mixers, extruders and twin screw extruders. Mixing of the individual constituents may proceed in a known manner either successively or simultaneously, and indeed either at for instance 20° C. (room temperature) or at a higher temperature. The compositions produced in this way are then used to produce mouldings of all types. These may be produced for example by injection moulding, extrusion and blow moulding processes. Another type of processing is the production of mouldings by thermoforming from previously produced sheets or films.

Examples of such mouldings are films, profiles, casing components of all kinds, for example for domestic appliances such as juice extractors, coffee machines, mixers; for office machines such as monitors, printers, copiers; also sheets, tubes, electrical ducting, profiles for the construction sector, interior fittings and exterior applications; components from the field of electrical engineering, such as switches and connectors, and automotive interior and exterior components.

In particular, the compositions according to the invention may be used for example for the production of the following mouldings:

interior fittings for rail vehicles, ships, aircraft, buses and cars, casings for electrical appliances containing miniature transformers, casings for equipment for broadcasting and transmitting information, casings and coverings for medical purposes, massagers and casings therefor, large-area wall elements, casings for safety apparatus, mouldings for sanitary and bathroom fittings, and casings for garden tools.

The following Examples serve solely to illustrate the invention further.

### EXAMPLES

Mouldings of various polymers (layer S2, substrate) were coated with the multilayer system (layer S1) illustrated in Table 1 by the PVD method (electron beam vapour deposition). Cleaning or activation of the substrate surface proceeded by ion-assisted activation in an Ar/O₂ mixture.

Layer S1-I or S1-II was vapour-deposited in a cluster coating installation made by VON ARDENNE Anlagentechik by electron beam vapour deposition (plasma-free PVD method) at a pressure of approx. 2.0-10⁻⁶ mbar and deposition rates of 0.5-1.0 nm/s. Application of the respective coating proceeded directly after brief pretreatment/activation of the substrate surface with argon and oxygen ions, without interrupting the vacuum and without cooling the substrate.

TABLE 1
Structure of layer S1 of the composite mouldings

| | Structure of layer S1 | | | |
|---|---|---|---|---|
| | S1-I | | S1-II | |
| | Composition | Thickness | Composition | Thickness |
| Protective layer (S) | SiO₂ | 100 nm | — | — |
| Functional layer (F) | Cu | 500 nm | Ni | 27 μm |
| Coupling layer (H) | Cr | 100 nm | Cr | 60 nm |

| | | |
|---|---|---|
| Used in | Examples 2, 4, 6, 8, 10, | Comparative Example 17 |
| | 12, 14, 15, 16 and 18 | |

The mouldings used were made up of the polymeric materials listed below. In the case of the PC/ABS compositions of (Comparative) Examples 5 to 18, in order to produce them on a twin screw extruder (ZSK-25) (Werner & Pfleiderer) the feed materials listed in Table 3 were compounded and granulated at a rotational speed of 225 rpm and a throughput of 20 kg/h at a machine temperature of 260° C. and then the finished granules were processed on an injection moulding machine to yield the corresponding specimens (melt temperature 260° C., mould temperature 80° C., flow front velocity 240 mm/s).

Component A1

Linear polycarbonate based on bisphenol A with a relative solution viscosity of ηᵣₑₗ=1.275, measured in CH₂Cl₂ as solvent at 25° C. and a concentration of 0.5 g/100 ml.

Component A2

Branched polycarbonate based on bisphenol A with a relative solution viscosity of ηᵣₑₗ=1.34, measured in CH₂Cl₂ as solvent at 25° C. and a concentration of 0.5 g/100 ml, which polycarbonate was branched by using 0.3 mol % isatin biscresol relative to the sum of bisphenol A and isatin biscresol.

Component A3

Linear polycarbonate based on bisphenol A with a relative solution viscosity of ηᵣₑₗ=1.20, measured in CH₂Cl₂ as solvent at 25° C. and a concentration of 0.5 g/100 ml.

Component A4

Linear polycarbonate based on bisphenol A with a relative solution viscosity of ηᵣₑₗ=1.288, measured in CH₂Cl₂ as solvent at 25° C. and a concentration of 0.5 g/100 ml.

Component B1

ABS polymer, produced by emulsion polymerisation of 43 wt. %, relative to the ABS polymer, of a mixture of 27 wt. % acrylonitrile and 73 wt. % styrene in the presence of 57 wt. %, relative to the ABS polymer, of a particulately crosslinked polybutadiene rubber (average particle diameter d₅₀=0.35 μm).

Component B2

Styrene/acrylonitrile copolymer with a styrene/acrylonitrile weight ratio of 72:28 and an intrinsic viscosity of 0.55 dl/g (measurement in dimethyl formamide at 20° C.).

Component B3

ABS polymer produced by bulk polymerisation of 82 wt. %, relative to the ABS polymer, of a mixture 24 wt. % acrylonitrile and 76 wt. % styrene in the presence of 18 wt. %, relative to the ABS polymer, of a polybutadiene-styrene block copolymer rubber with a styrene content of 26 wt. %. The weight-average molecular weight w of the free SAN copolymer fraction in the ABS polymer amounts to 80000 g/mol (measured by GPC in THF). The gel content of the ABS polymer amounts to 24 wt. % (measured in acetone).

Component C1

Polytetrafluoroethylene powder, CFP 6000, DuPont.

Component C2

Teflon masterbatch consisting of 50 wt. % styrene/acrylonitrile copolymer and 50 wt. % PTFE (Blendex® 449, GE Speciality Chemicals, Bergen op Zoom, Netherlands).

Component D1

Bisphenol A-based oligophosphate 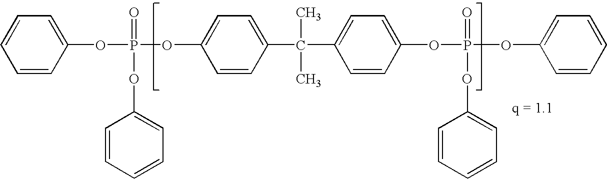
Component D2

Triphenyl phosphate, Disflamoll TP® made by Lanxess GmbH, Germany.

Component E1

Pentaerythritol tetrastearate

Component E2

Phosphite stabiliser, Irganox® B 900, Ciba Speciality Chemicals

Component E3

Aluminium oxide hydroxide, average particle size d₅₀ is approx. 20-40 nm (Pural® 200, Sasol, Hamburg).

Component E4

Talcum, Luzenac® A3C made by Luzenac Naintsch Mineralwerke GmbH with an MgO content of 32 wt. %, an SiO₂ content of 61 wt. % and an Al₂O₃ content of 0.3 wt. %.

The properties “time to ignition” and FIGRA (peak of heat release rate/time of peak of heat release rate), stated in Tables 2 and 3 below, of the mouldings coated according to the invention and the corresponding uncoated mouldings were determined in a Cone Calorimeter at 50 kW·m⁻² to ISO 5660.

Accuracy of reproduction is assessed visually using textured sheets with different grains and contours. To this end, the following assessment scheme was applied:
high: very fine grains and contours are easy to detect
moderate: very fine grains and contours disappear
low: differences in the surface structure can only be detected with difficulty

The scratch test was performed in accordance with DIN EN 1071-3 (equipment parameters: Rockwell C type indenter, cone angle 120 degrees, radius of curvature of tip 0.2 mm; mode of operation: increasing normal load (maximum 90 N)). As assessment criterion, it is stated whether delamination has occurred in this test.

TABLE 2
Flammability of coated polymers in comparison with uncoated
samples: time to ignition and flame spread on exposure to elevated
levels of external radiant heat.

| | 1 | | 3 | |
|---|---|---|---|---|
| | (Comparison) | 2 | (Comparison) | 4 |
| Composition | | | | |
| Layer S1 | — | S1-I | — | S1-II |
| Substrate: | Polycarbonate, | Polycarbonate, | PA 66 | PA 66 |
| Polymer | Makrolon ® | Makrolon ® | Ultramid ® A | Ultramid ® A |
| | 2605 from | 2605 from | (unreinforced), | (unreinforced), |
| | Bayer | Bayer | A3 from BASF | A3 from BASF |
| | MaterialScience | MaterialScience | AG | AG |
| | AG | AG | | |
| Properties | | | | |
| Time to ignition | 88 s | 643 s | 53 s | 511 s |
| [s] | | | | |
| FIGRA | 2.34 | 1.60 | 3.26 | 1.57 |
| [kW · m⁻² · s⁻¹] | | | | |

PA: Polyamide

TABLE 3
Influence of the coating in the case of polymers flameproofed with
additives: time to ignition and flame spread on
exposure to elevated levels of external radiant heat

| | 5 | | 7 | | 9 | | 11 | | 13 | |
|---|---|---|---|---|---|---|---|---|---|---|
| Composition | (Comp.) | 6 | (Comp.) | 8 | (Comp.) | 10 | (Comp.) | 12 | (Comp.) | 14 |
| Layer S1 | — | S1-I | — | S1-I | — | S1-I | — | S1-I | — | S1-I |

Substrate: Polymer made up of

| | | | | | | | | | | |
|---|---|---|---|---|---|---|---|---|---|---|
| A1 | 41.7 | 41.7 | 51.4 | 51.4 | — | — | 52.3 | 52.3 | 69.5 | 69.5 |
| A2 | — | — | — | — | 84.8 | 84.8 | — | — | — | — |
| A3 | 24.0 | 24.0 | 12.4 | 12.4 | — | — | 16.0 | 16.0 | 24.3 | 24.3 |
| B1 | 11.1 | 11.1 | 9.0 | 9.0 | 4.7 | 4.7 | 9.8 | 9.8 | 3.0 | 3.0 |
| B2 | 7.5 | 7.5 | 10.4 | 10.4 | — | — | 7.5 | 7.5 | — | — |
| C1 | 0.4 | 0.4 | 0.5 | 0.5 | 0.1 | 0.1 | 0.4 | 0.4 | 0.4 | 0.4 |
| D1 | 14.0 | 14.0 | 15.0 | 15.0 | 10.1 | 10.1 | 10.1 | 10.1 | 2.3 | 2.3 |
| D2 | — | — | — | — | — | — | 3.4 | 3.4 | — | — |
| E1 | 0.4 | 0.4 | 0.4 | 0.4 | 0.2 | 0.2 | 0.4 | 0.4 | 0.4 | 0.4 |
| E2 | 0.1 | 0.1 | 0.1 | 0.1 | 0.1 | 0.1 | 0.1 | 0.1 | 0.1 | 0.1 |
| E3 | 0.8 | 0.8 | 0.8 | 0.8 | — | — | — | — | — | — |

Properties

| | | | | | | | | | | |
|---|---|---|---|---|---|---|---|---|---|---|
| Time to ignition [s] | 54 | 241 | 54 | 232 | 76 | 351 | 60 | 282 | 71 | 333 |
| FIGRA [kW · m⁻² · s⁻¹] | 1.96 | 0.70 | 1.89 | 0.73 | 2.10 | 0.76 | 1.21 | 0.62 | 2.24 | 0.63 |

TABLE 4
Influence of the coating in the case of polymers flameproofed with
additives: time to ignition, flame spread on exposure to elevated
levels of external radiant heat, adhesion and reproduction accuracy

| | | | 17 | |
|---|---|---|---|---|
| | 15 | 16 | (Comp.) | 18 |
| Composition | | | | |
| Layer S1 | S1-I | S1-I | S1-II | S1-I |

Substrate: Polymer made up of

| | | | | |
|---|---|---|---|---|
| A1 | 58.0 | 77.3 | 77.3 | — |
| A4 | — | — | — | 70.6 |
| B1 | 9.7 | 7.7 | 7.7 | 6.0 |
| B2 | 3.0 | 3.5 | 3.5 | — |
| B3 | — | — | — | 8.4 |
| C1 | — | 0.4 | 0.4 | — |
| C2 | 0.8 | — | — | 0.9 |
| D1 | 13.0 | 9.8 | 9.8 | 13.0 |
| E1 | 0.4 | 0.4 | 0.4 | — |
| E2 | 0.1 | 0.1 | 0.1 | 0.2 |
| E3 | — | 0.8 | 0.8 | 0.9 |
| E4 | 15.0 | — | — | — |

Properties

| | | | | |
|---|---|---|---|---|
| Time to ignition [s] | | 613 | | 392 |
| FIGRA [kW · m⁻² · s⁻¹] | | 0.31 | | 0.37 |
| Reproduction accuracy of | high | high | moderate | high |
| coating | | | | |
| Scratch test to DIN EN ISO | | no | yes | |
| 1071 delamination | | | | |

A distinct increase in protective action was measured by the Cone Calorimeter test to ISO 5660 for time to ignition and flame spread (FIGRA) using the example of a three-layer system produced by vapour deposition, wherein, in addition to a middle metallic protective layer (metallic mirror) which performs the flameproofing function and is optically dense in the IR range, a lower, coupling layer or a lower layer exhibiting a barrier effect and requiring optimisation relative to the respective substrate and a top layer providing protection against environmental influences, such as oxidation and mechanical damage, are applied. The middle metallic layer is the actual functional layer providing fire protection for the purposes of the invention. The time to ignition is extended by a factor of 5 to 10 and the FIGRA by a factor of ½-¼. With the layers S1 according to the invention, high reproduction accuracies may be achieved, i.e. even very fine contours on the surface of the textured sheets used as substrate, with different grains and contours, are easy to detect. In the case of the thicker layer S1-II used for comparison, very fine grains and contours of the surface of the substrate disappear after coating. Adhesion of the thicker layer S1-II does not fulfil the requirements according to the invention either: in the scratch test to DIN EN 1071-3 the layer S1-II undergoes delamination from the substrate (Comparative Example 17). In contrast, the layer S1-I according to the invention does not delaminate during this scratch test (Example 16).

It should be noted in general that the solution according to the invention (functional principle of sufficient integral IR reflection) requires a layer which is optically dense in the infrared range and avoids the problems of maladaptation which increase with an increasing film thickness (above all in the case of film thicknesses greater than 10000 nm). Typically, with thicker film thicknesses (from 10000 nm), accuracy of reproduction of surface features worsens, layer stresses increase and layer adhesion and the mechanical stress profile worsen, wherein the latter becomes apparent in particular in relation to the flexibility or the bendability and extensibility which has always to be taken into account in the case of polymers and which may manifest itself in detachment of the layers on bending or extension of the composite materials.

1. A multilayer product, wherein the first layer is a layer which is optically dense in the infrared range, and wherein the second layer contains a polymer as substrate.

2. A multilayer product according to claim 1, wherein the first layer is a metal selected from the main group 1 to 5 or subgroup 1 to 8 of the periodic system or is an alloy of at least two of these metals or stainless steel.

3. A multilayer product according to claim 1 or claim 2, wherein the first layer exhibits a film thickness of from 3 nm to 10000 nm.

4. A multilayer product according to claim 1, wherein the first layer is made up of a coupling layer (H), a functional layer (F) and optionally a protective layer (S), wherein the layer sequence corresponds to the stated sequence starting from the layer following the substrate.

5. A multilayer product according to claim 4, wherein the coupling layer (H) consists of a metal such as chromium, nickel, a nickel/chromium alloy or of stainless steel, the functional layer (F) is a metal selected from main group 1 to 5 or subgroup 1 to 8 of the periodic system or an alloy of at least two of the stated metals or stainless steel or a hard layer, and the protective-layer (S) consists of at least one component selected from the group consisting of SiO₂, TiO₂, Al₂O₃ and hard layers.

6. A multilayer product according to claim 4 or claim 5, wherein the thickness of the coupling layer (H) amounts to from 1 nm to 200 nm, the thickness of the functional layer (F) to from 3 nm to 10000 nm and the thickness of the protective layer (S) to from 10 nm to 1000 nm.

7. A multilayer product according to any one of claims 1 to 6, wherein a thermoplastic, thermoset or rubber is used as the polymer of the second layer.

8. A multilayer product according to any one of claims 1 to 6, wherein at least one polymer selected from the group consisting of polystyrene, polyurethane, polyamide, polyester, polyacetal, polyacrylate, polycarbonate, polyethylene, polypropylene, polyvinyl chloride, polystyrene/acrylonitrile or a copolymer based on the stated polymers is used as the polymer of the second layer.

9. A multilayer product according to any one of claims 1 to 6, wherein at least one polymer containing polycarbonate is used as the polymer of the second layer.

10. A multilayer product according to any one of claims 1 to 6, wherein a polycarbonate composition containing
A) 40-100 parts by weight of aromatic polycarbonate and/or aromatic polyester carbonate,
B) 0-40 parts by weight of a polymer selected from the group consisting of vinyl (co)polymers, rubber-modified vinyl (co)polymers and polyesters,
C) 0 to 5 parts by weight of fluorinated polyolefin, wherein these stated quantities relate to the pure fluorinated polyolefin when using a coagulate, precompound or masterbatch,
D) 0-20 parts by weight of flame-retardant additives, and
E) 0-25 parts by weight of further polymers and/or polymer additives, is used as the polymer of the second layer.

11. A method of producing multilayer products according to any one of claims 1 to 10, characterised in that PVD (physical vapour deposition), ECD (electro-coating deposition), CVD (chemical vapour deposition) methods or sol-gel methods are used for coating the polymer of the second layer with a first layer (S1).

12. Use of a layer of metal which is optically dense in the infrared range as a coating for mouldings of polymers to improve flame resistance.

13. Use of the multilayer products according to claims 1 to 10 to produce mouldings.

14. A moulding comprising a multilayer product according to any one of claims 1 to 10.

15. A moulding according to claim 14, characterised in that the multilayer product is a film, profile, casing component of all kinds, sheet, tube, electrical ducting, profile for the construction sector, interior fittings and exterior applications; a component from the field of electrical engineering, such as a switches and connectors, ceiling or wall trim in rail vehicles, or an automotive interior or exterior component for a motor vehicle, rail vehicle, aircraft or water-borne vehicle.

16. A method of improving the flame resistance of mouldings made from polymers, characterised in that the mouldings are coated with a layer of metal which is optically dense in the infrared range in a film thickness of from 3 nm to 10000 nm.

17. A method according to claim 16, characterised in that the polymer contains polycarbonate.

18. A method according to claim 16, characterised in that the polymer is a polycarbonate composition, containing
A) 40-100 parts by weight of aromatic polycarbonate and/or aromatic polyester carbonate,
B) 0-40 parts by weight of a polymer selected from the group consisting of vinyl (co)polymers, rubber-modified vinyl (co)polymers and polyesters,
C) 0 to 5 parts by weight of fluorinated polyolefin, wherein these stated quantities relate to the pure fluorinated polyolefin when using a coagulate, precompound or masterbatch,
D) 0-20 parts by weight of flame-retardant additives, and
E) 0-25 parts by weight of further polymers and/or polymer additives.
